(19) United States
(12) Patent Application Publication
(10) Pub. No.: US 2021/0125288 A1
(43) Pub. Date: Apr. 29, 2021

(54) MANAGEMENT INFORMATION SYSTEM, METHOD, AND PROGRAM CAPABLE OF REVALUATION

(71) Applicant: SUMITOMO MITSUI BANKING CORPORATION, Tokyo (JP)

(72) Inventors: Kiyonori UGAJIN, Tokyo (JP); Hirofumi IMAMOTO, Tokyo (JP)

(21) Appl. No.: 16/493,921

(22) PCT Filed: Mar. 17, 2017
(86) PCT No.: PCT/JP2017/011057

§ 371 Date: Sep. 13, 2019

(51) Int. Cl. G06Q 40/00; G06Q 40/02; G06Q 40/06; G06Q 40/08

(52) U.S. Cl. CPC G06Q 40/12; G06Q 40/08; G06Q 40/06; G06Q 40/02

(57) ABSTRACT

Provided are a system, method, and program capable of performing a data replacement process in databases managed by multiple business systems in a financial institution for the management of the institution. A management information system includes a data replacement unit. The system supports management of a financial institution or a financial holding company group including the financial institution. The data replacement unit receives, from any of the terminals, data for identifying a basic figure to be regenerated in data replacement and a change value of ground data for performing the data replacement, identifies standardized data composing the basic figure identified with the received data, recalculates the standardized data using the received change value of the ground data, and regenerates the basic figure based on the recalculated standardized data, the basic figure being used for the management of the financial institution or the financial holding company group.

### TECHNICAL FIELD

The present invention relates to a technique for providing information that is referred to for a managerial judgment or decision making of a financial institution or a financial holding company group. More particularly, the present invention relates to a technique to manage data used for the management accounting and financial accounting of a financial institution or a financial holding company group.

### BACKGROUND ART

Accounting information on management accounting, a kind of corporate accounting, is referred to in order to make a managerial judgment or decision of a financial institution or a financial holding company group. In management accounting, various kinds of information inside the company are collected and analyzed according to the purpose to provide numerical values for enabling grasping of the managerial situation and issues.

For example, for management accounting of a financial institution or a financial holding company group, it is necessary to grasp the actual situations of operations such as deposits, lending, and currency exchange at domestic and foreign locations. In addition, it is necessary to grasp not only the management situation within the company but also those of group companies under the same financial holding company. Thus, the management accounting of a financial institution or a financial holding company group is required to use a wide variety of information scattered widely across the company and the group companies.

In addition, the management accounting of a financial institution or a financial holding company group needs to handle matters such as credit risk, market risk, liquidity risk, and domestic and foreign financial regulations that cannot be handled in conventional financial accounting frameworks. Operations in the financial institution involve various risks. Nowadays, it is required to quantify these risks and include them in the accounting information of management accounting.

Conventionally, a staff member in a financial institution collects data scattered across databases in all business systems inside the company and analyses the data on a personal computer at hand to generate accounting information of management accounting. Specifically, a staff member combines partial information pieces scattered across multiple databases—part of data in a database in the company, part of data in another database, part of data in still another database, and so on—to generate accounting information of management accounting.

### SUMMARY OF INVENTION

### Technical Problem

Unfortunately, a financial institution and its group companies have a large number of business systems including an accounting system, and each business system has an immense number of databases. In addition, these databases are not formed consistently among the departments and group companies, in other words, among the business systems. Each of the departments and group companies defines items in a database independently and calculates numerical values of those items on its own grounds. In other words, data inside a company is not managed based on common definitions and common calculation grounds across all the departments and all the group companies. Thus, it has been difficult to manage data in those databases as accounting information of management accounting based on a consistent system and provide the data for the managers in a timely and appropriate manner.

In particular, financial information and risk information have conventionally been managed separately and thus have not necessarily been managed on the same basis. Thus, it has been difficult to provide information on risks involved in operations of a financial institution for the managers in a timely and appropriate manner.

In addition, the management accounting of a financial institution or a financial holding company group often handles information calculated using variable values such as exchange rates, rates, and lending rates. In other words, data values of each item in each database in each business system can change in conjunction with an exchange rate or the like. Thus, for example, accounting information of management accounting is different depending on the exchange rate of which time is used. Thus, the management accounting of a financial institution or a financial holding company group requires the capability of recalculating data of each item in databases with values such as exchange rates changed according to the purpose (data replacement process).

The present invention has been made in light of the above problems, and an object thereof is to provide a system, method, and program capable of performing a data replacement process to regenerate data in databases managed by multiple business systems in a financial institution or a financial holding company in order to provide information for the managers of the company in a timely and appropriate manner.

### Solution to Problem

To achieve the objective, an aspect of the present invention is a management information system connected to multiple business systems and terminals inside and outside a company, located in a home country and a foreign country, the management information system including a data replacement unit. The management information system is a system to support management of a financial institution or a financial holding company group including the financial institution. The data replacement unit is configured to receive, from any of the terminals, data for identifying a basic figure to be regenerated in data replacement and a change value of ground data for performing the data replacement, identify standardized data composing the basic figure identified with the received data, recalculate the standardized data using the received change value of the ground data, and regenerate the basic figure based on the recalculated standardized data, the basic figure being used for the management of the financial institution or the financial holding company group including the financial institution.

### Advantageous Effects of Invention

The present invention makes it possible to perform a data replacement process to regenerate data in databases managed by multiple business systems in a company or in group companies under a financial holding company, according to the purpose of using the data.

### BRIEF DESCRIPTION OF DRAWINGS

FIG. 1 is an overall schematic diagram including a management information system according to an embodiment of the present invention;

FIG. 2 is a functional block diagram of the management information system according to the embodiment of the present invention;

FIG. 3 is a data transition diagram of the management information system according to the embodiment of the present invention;

FIG. 4 is an example of data of the management information system according to the embodiment of the present invention;

FIG. 5 is an example of a standardized data definition database of the management information system according to the embodiment of the present invention;

FIG. 6 is an example of a common code database of the management information system according to the embodiment of the present invention;

FIG. 7 is an example of a calculation ground database of the management information system according to the embodiment of the present invention;

FIG. 8 is a sequence diagram illustrating a process procedure of the management information system according to the embodiment of the present invention; and

FIG. 9 is a sequence diagram illustrating a process procedure of the management information system according to the embodiment of the present invention.

### DESCRIPTION OF EMBODIMENTS

Hereinafter, an embodiment of the present invention will be described in detail with reference to the drawings. In this specification, the present invention will be described mainly in terms of management accounting, but the present invention can be utilized to generate accounting information on management accounting and financial accounting. The present invention can be used to generate accounting information on the management accounting and financial accounting of a financial institution, the management accounting and financial accounting of a whole financial holding company group, and the management accounting and financial accounting of group companies under a financial holding company.

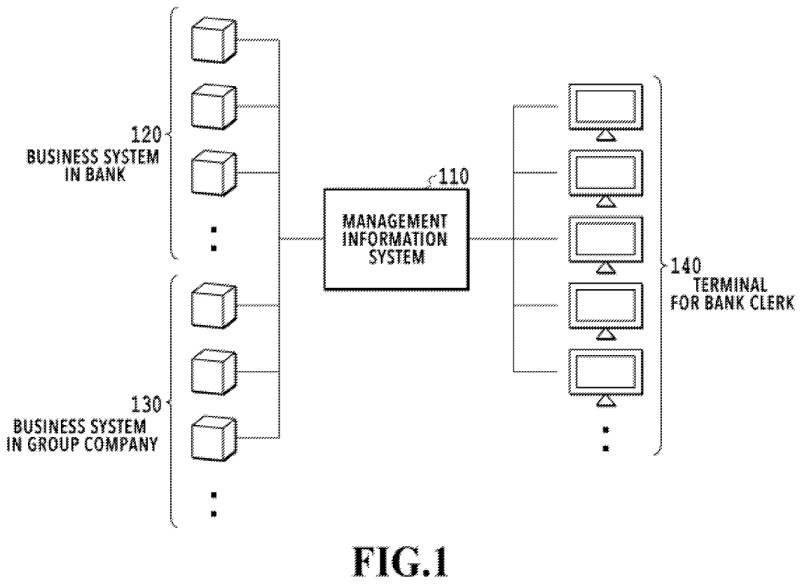

With reference to FIG. 1, first an overall configuration including a management information system 110 according to an embodiment of the present invention is explained. The management information system 110 is a system for compiling and managing information in databases held by multiple business systems 120 and 130, for the management accounting and financial accounting of a bank or a financial holding company group. The business systems 120 in the bank are business systems such as an accounting systems in the bank. The business systems 130 in the group companies are business systems in group companies (such as a securities company) of the bank. Terminals 140 for bank clerks are terminals for bank clerks to use the management information system 110. Hereinafter, each system and terminal will be described in detail.

Note that the business systems 120 and 130 are systems located in the home country and foreign countries and may include systems for financial operations of the bank and the group companies and systems for any operations other than finance (for example, risk management and the like). Thus, the management information system 110 is capable of compiling not only data on financial operations but also data that has not been used for conventional financial accounting including data on risks such as credit risk, and making use of them for the management accounting and financial accounting.

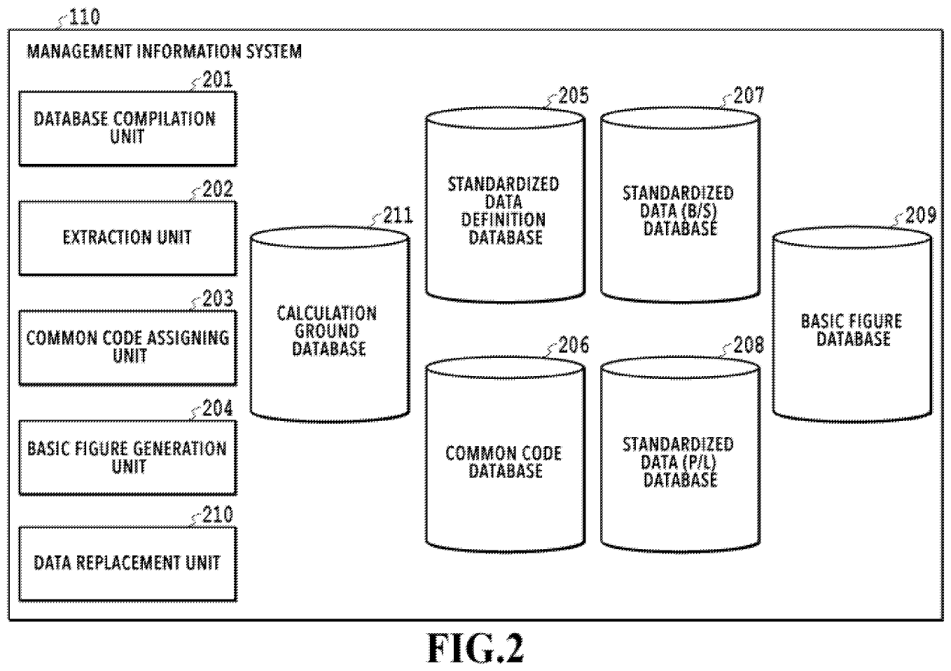

The management information system 110 is a system for supporting the management of a financial institution or a financial holding company group including a financial institution. The management information system 110 extracts data of some items in databases held by the business systems 120 in a bank and the business systems 130 in group companies and assigns common codes to this extracted data, so that data in the business systems 120 and 130 can be made use of for the management accounting and financial accounting of the bank or the financial holding company group. In addition, the management information system 110 is capable of performing a data replacement process for the data to which common codes are assigned. Hereinafter, the management information system 110 will be described in detail with reference to FIG. 2.

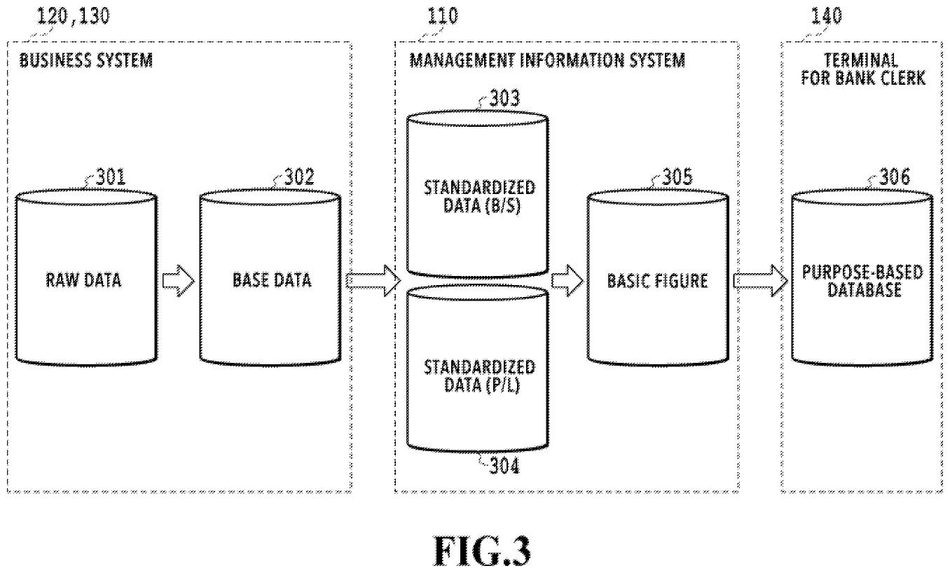

FIG. 2 is a functional block diagram of the management information system 110 according to an embodiment of the present invention. The management information system 110 may include a database compilation unit 201, extraction unit 202, common code assigning unit 203, basic figure generation unit 204, data replacement unit 210, standardized data definition database 205, common code database 206, standardized data (B/S) database 207, standardized data (P/L) database 208, basic figure database 209, and calculation ground database 211. The management information system 110 is a computer including a processor and memory. The management information system 110 also includes a storage medium storing a program for causing the database compilation unit 201, extraction unit 202, common code assigning unit 203, basic figure generation unit 204, and data replacement unit 210 to operate, or a program for executing process procedures described later. The management information system 110 can transmit and receive data to and from each of the business systems 120 in the bank, the business systems 130 in the group companies, and the terminals 140 for bank clerks. Before each of the database compilation unit 201 to the calculation ground database 211 is described in detail, data transition in the present invention will be described below in detail with reference to FIG. 3.

FIG. 3 is a data transition diagram for the management information system according to the embodiment of the present invention.

### <Raw Data>

First, raw data 301 in the business systems 120 and 130 will be described. The raw data 301 is raw data stored in the business systems 120 and 130. The raw data 301 includes, for example, data such as deposit and withdrawal details of accounts, fees, credit details, collateral/guarantee details, rating information, market-based revenue, and expenses.

<Base data>

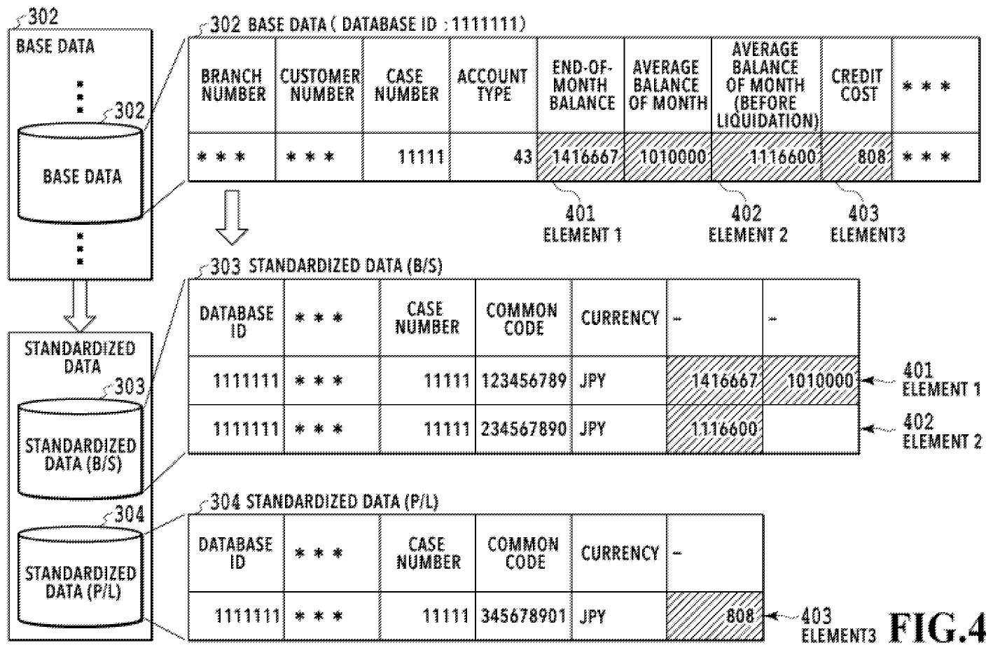

Next, base data 302 in the business systems 120 and 130 will be described. The base data 302 can be generated based on the raw data 301. Each of the business systems 120 and 130 can build databases for its operation based on the raw data 301 (this database is called base data 302). The base data 302 includes data of one or more items. As described later, data of some items is extracted out of the base data 302 to be used for standardized data 303 or 304. The base data 302 is, for example, a database on domestic or foreign deposit operation, a database on domestic or foreign lending operation, and the like. A specific example of the base data 302 will be described with reference to FIG. 4.

### <Standardized Data>

Next, the standardized data 303 and 304 in the management information system 110 will be described. The standardized data 303 and 304 can be generated based on the base data 302. The management information system 110 can extract data of some selected items in the base data 302. The number of the selected items may be one or more (hereinafter, these “selected items” are also referred to as the “elements”). In addition, the management information system 110 can generate the standardized data 303 or 304 by assigning common codes to this extracted data (in other words, by assigning a common code to data of each element). The standardized data can be classified into the standardized data 303 on B/S (balance sheet) and the standardized data 304 on P/L (profit-and-loss statement). As described later, multiple pieces of standardized data 303 and 304 are combined to be used as basic figures 305. A specific example of the standardized data 303 and 304 will be described with reference to FIG. 4.

### <Basic Figure>

Next, the basic figures 305 in the management information system 110 will be described. The basic figures 305 can be generated based on the standardized data 303 and 304. The management information system 110 can generate the basic figures 305 by combining multiple pieces of standardized data 303 and 304 based on common codes. The basic figures 305 include, for example, a database in which pieces of standardized data 303 and 304 are combined for each customer, a database in which pieces of standardized data 303 and 304 are combined for each transaction (deal), and the like. The basic figures are used for the management of a financial institution or a financial holding company group including a financial institution. As described later, a purpose-based database 306 are built based on the basic figures 305.

### <Purpose-Based Database>

Lastly, the purpose-based database 306 in the terminal 140 for bank clerks will be described. The purpose-based database 306 can be built based on the basic figures 305. The terminal 140 for bank clerks can build the database 306 for a specific purpose using the basic figures 305. In addition, the terminal 140 for bank clerks can store the built purpose-based database 306 in the management information system 110. The purpose-based database 306 is accounting information including numerical values into which risks such as credit risk are quantified. Specifically, the accounting information on management accounting or financial accounting generated using the present invention is accounting information calculated from risk information and financial information the outer shape of which are unified.

FIG. 4 is an example of data of the management information system 110 according to the embodiment of the present invention. In the example of FIG. 4, the base data 302 is on the operation of lending (financing). For example, the base data 302 includes data of items such as “end-of-month balance”, “average balance of the month”, “average balance of the month (before liquidation)”, and “credit costs”. Note that here the “end-of-month balance” and “average balance of the month” will be referred to as element 1 401, the “average balance of the month (before liquidation)” as element 2 402, and the “credit costs” as element 3 403. In the base data 302 in FIG. 4, data is managed on a lending-case basis (in other words, on a financing-transaction basis or a deal basis). Thus, the base data 302 is managed by the record, for example, on a case basis, on a contract basis, on a deal basis, on an account basis, and on a customer basis, depending on the operation of each department.

The lower right part of FIG. 4 shows the standardized data 303 and 304. Specifically, data of the element 1 401 of the base data 302 (specifically, the “end-of-month balance” and “average balance of the month”) is extracted and stored in the standardized data (B/S) 303 (in the upper part). Then the common code “123456789” is assigned to this data of element 1 401. In addition, data of element 2 402 in the base data 302 (specifically, the “average balance of the month (before liquidation)”) is extracted and stored in the standardized data (B/S) 303 (in the lower part). Then the common code “234567890” is assigned to this data of element 2 402. In the standardized data (P/L) 304, data of element 3 403 in the base data 302 (specifically, “credit costs”) is extracted and stored. Then the common code “345678901” is assigned to this data of element 3 403. Thus, one piece of base data 302 that is managed with the case number “11111” is divided into three pieces of standardized data 303 and 304. In other words, a piece of base data 302 that is managed as one record is divided into multiple pieces of standardized data 303 and 304, and a common code is assigned to each piece.

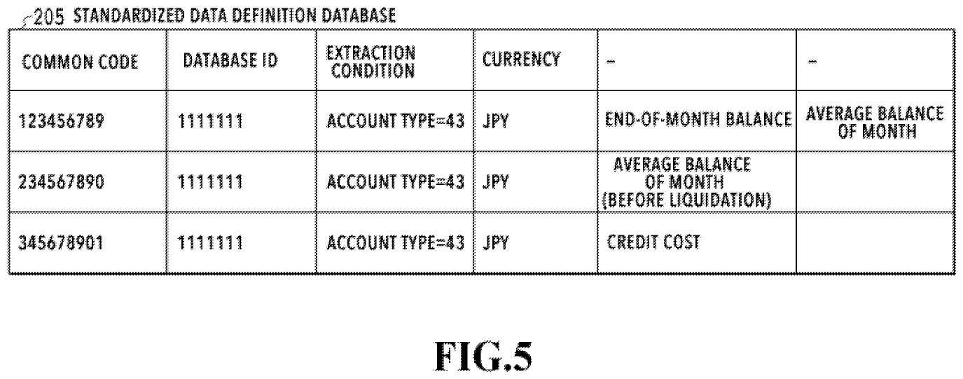

As will be described below with reference to FIG. 5, the management information system 110 can determine the data of which items is to be extracted as the standardized data 303 and 304 out of the multiple items in the base data 302 based on the standardized data definition database 205. In addition, the management information system 110 can assign common codes to the extracted data based on the standardized data definition database 205.

FIG. 5 is an example of a standardized data definition database 205 of the management information system according to the embodiment of the present invention. As described above, the standardized data definition database 205 is a database for specifying the items the data of which is to be extracted as the standardized data 303 and 304 out of the multiple items in the base data 302. The standardized data definition database 205 can define any extraction conditions such as the identifiers of databases (indicating which database) in the business systems 120 and 130 and item names (indicating which items). As described above, the standardized data definition database 205 is a database also for specifying common codes to be assigned to extracted data. The standardized data definition database 205 can define common codes for data of one or more items to be extracted (in other words, data of each element).

As above, the base data 302 in databases of the business systems 120 and 130 is managed as the standardized data 303 and 304 so that it can be easily used for the management accounting and financial accounting. In other words, data including multiple elements adapted to operations (in other words, the base data 302) is componentized into data on an element basis (in other words, the standardized data 303 and 304).

Returning to FIG. 2, each of the database compilation unit 201 to the calculation ground database 211 will be described in detail below.

The database compilation unit 201 can receive base data 302 from the business systems 120 in the bank and the business systems 130 in the group companies. The database compilation unit 201 can store the received base data 302 in memory (not illustrated).

The extraction unit 202 can extract data of some items in the base data 302 received by the database compilation unit 201 based on the standardized data definition database 205. The extraction unit 202 can store the extracted data in memory (not illustrated).

The common code assigning unit 203 can assign common codes to the data extracted by the extraction unit 202, based on the standardized data definition database 205. Specifically, the common code assigning unit 203 can associate the data extracted by the extraction unit 202 with the common codes defined for the extracted data in the standardized data definition database 205 and can store the associated data and common codes in the standardized data (B/S) database 207 or the standardized data (P/L) database 208. Whether data is to be stored in the standardized data (B/S) database 207 or the standardized data (P/L) database 208 is determined based on its common code.

The basic figure generation unit 204 can generate basic figures 305 by combining multiple pieces of standardized data 303 and 304 in the standardized data (B/S) database 207 and the standardized data (P/L) database 208. Specifically, the basic figure generation unit 204 can combine multiple pieces of standardized data 303 and 304 based on the common codes assigned to the standardized data 303 and 304. As above, data including multiple data pieces of standardized data 303 and 304 (in other words, the basic figures 305), adapted for each operation is generated based on the common codes of the standardized data 303 and 304.

The standardized data definition database 205 is, as has been described with reference to FIG. 5, a database for storing information on the items of the data of which is to be extracted as the standardized data 303 and 304 and the common codes to be assigned to the extracted data. Based on the standardized data definition database 205, the standardized data 303 and 304 is generated from the base data 302.

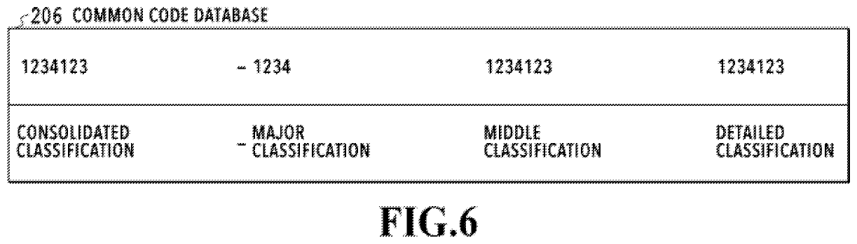

The common code database 206 is a database that stores the definition of each common code. The same common codes are codes shared throughout the bank and the group companies. The common codes enable the content of the data of the standardized data 303 and 304 to be identified. As illustrated in FIG. 6, the common codes have multiple classifications. The common code of a data piece of standardized data specifies whether the data piece is to be classified into the standardized data (B/S) 303 or the standardized data (P/L) 304. One of the common codes in the common code database 206 is assigned to each element in the standardized data definition database 205.

The standardized data (B/S) database 207 is a database that stores standardized data concerning balance sheets (B/S) of the standardized data.

The standardized data (P/L) database 208 is a database that stores standardized data concerning profit-and-loss statement (P/L) of the standardized data.

The basic figure database 209 is a database that stores data on the basic figures 305 generated by the basic figure generation unit 204. The basic figure database 209 can store information for identifying pieces of standardized data 303 and 304 composing each basic FIG. 305.

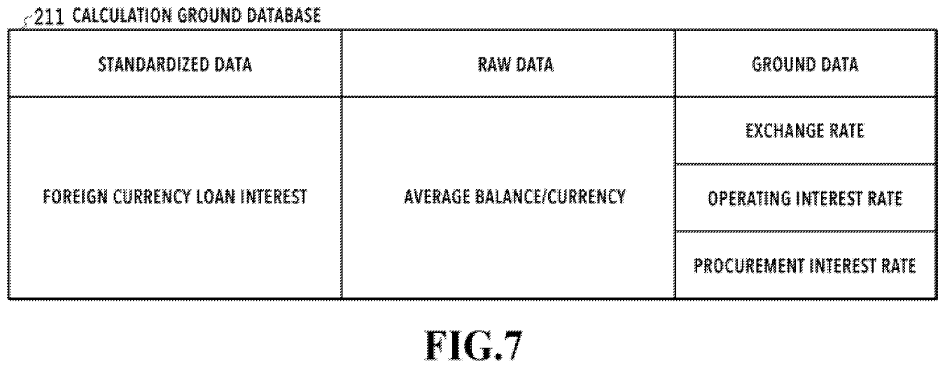

The calculation ground database 211 is a database used for performing a data replacement process. The calculation ground database 211 will be described in detail below with reference to FIG. 7.

FIG. 7 is an example of a calculation ground database 211 of the management information system according to the embodiment of the present invention. The calculation ground database 211 is a database storing the ground on which each piece of standardized data 303 and 304 (in other words, the data of each item in the base data 302) was calculated. Specifically, the calculation ground database 211 can store one or more pieces of raw data 301 and one or more pieces of ground data for each piece of standardized data 303 and 304. The ground data includes parameters used to generate the data of each item in the base data 302 from the raw data 301. Examples of the ground data include exchange rates, average exchange rates of the year, credit risk fee rates, liquidity settlement rates, prime rates, maturity-undesignated long-term rates, maturity-undesignated short-term rates, procurement cost rates, ratios of allowance, policy interest rates, and consumption tax rates. In the example of FIG. 7, a “foreign currency loan interest” in the standardized data is calculated based on an “average balance/currency” in the raw data and an “exchange rate”, “operating interest rate”, and “procurement interest rate” in the ground data.

As described above, the base data 302 is generated based on the raw data 301 and the ground data. Then, part of this base data 302 is extracted and used as the standardized data 303 and 304. After the raw data 301 and the base data 302 are generated, they are invariant and thus cannot be regenerated in a data replacement process, but the standardized data 303 and 304 can be recalculated based on the raw data 301 and the ground data. The standardized data 303 and 304 (in other words, data of the items in the base data 302) include data on risks such as credit risk. Thus, in the present invention, data on risks that occur along with operations of the financial institution can be regenerated in a data replacement process.

The data replacement unit 210 can perform a data replacement process. Specifically, the data replacement unit 210 can receive data from the terminal 140 for bank clerks for identifying the basic figures 305 that need to be regenerated in a data replacement process (in other words, the basic figures 305 to be regenerated in the data replacement process). The data replacement unit 210 can refer to the basic figure database 209 to identify the pieces of the standardized data 303 and 304 composing the basic figures 305 identified by the received data. In addition, the data replacement unit 210 can refer to the calculation ground database 211 to identify the pieces of the raw data 301 and ground data of the identified pieces of standardized data 303 and 304. In addition, the data replacement unit 210 can receive numerical values of the ground data from the terminal 140 for bank clerks (these numerical values (also referred to as change values) are used for the data replacement). In addition, the data replacement unit 210 can calculate standardized data 303 and 304 based on the identified pieces of raw data 301 and the received numerical values of the ground data. In addition, the data replacement unit 210 can generate basic figures 305 based on the calculated standardized data 303 and 304. As described above, in the case where the data replacement unit 210 receives “the basic figures to be regenerated in a data replacement process” and “the change values of the ground data for performing the data replacement process”, the data replacement unit 210 can recalculates standardized data using these change values, and, using the recalculated standardized data, regenerate “the basic figures to be regenerated in the data replacement process” into new basic figures.

Note that as another embodiment, the calculation ground database 211 may store data of one or more items of the base data 302 and one or more pieces of ground data for each piece of standardized data 303 and 304. In this case, the data replacement unit 210 refers to the calculation ground database 211 and identifies the “data of one or more items of the base data 302” and the “ground data” of the pieces of standardized data 303 and 304 composing the basic figures 305. Then, the data replacement unit 210 calculates standardized data 303 and 304 based on the identified “data of one or more items of the base data 302” and the received numerical values of ground data.

Returning to the explanation of FIG. 1, the business systems 120 in the bank are systems used for operations in the bank. The business systems 120 may include one or more business systems of any type, including accounting systems for bank operations, such as deposit, lending, and exchange operations.

The business systems 130 in the group companies are systems used for operations in the group companies. The group companies include group companies of the bank having the business systems 120 in the bank. The group companies may include not only companies that operate financial business but also companies that operate business other than financial business. The business systems 120 may include one or more business systems in a securities company and the like.

The terminals 140 for bank clerks are terminals such as personal computers for bank clerks to use the management information system 110. The bank clerks are bank clerks of the bank having the business systems 120 in the bank. The number of terminals 140 for bank clerks can be any number.

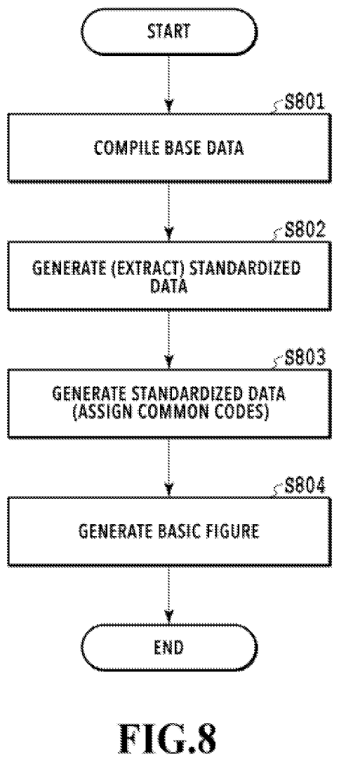

FIG. 8 is a sequence diagram illustrating a process procedure of the management information system 110 according to the embodiment of the present invention.

At step 801, the management information system 110 receives the base data 302 from the business systems 120 in the bank and the business systems 130 in the group companies.

At step 802, the management information system 110 extracts data of some items out of the data of the multiple items in the base data 302 received at step 801, based on the standardized data definition database 205.

At step 803, the management information system 110 assigns common codes to the data extracted at step 802, based on the standardized data definition database 205. With steps 802 and 803, the standardized data 303 and 304 is generated from the base data 302.

At step 804, the management information system 110 combines multiple pieces of standardized data 303 and 304 generated at steps 802 and 803, to generate the basic figures 305. The process procedure is performed as described above.

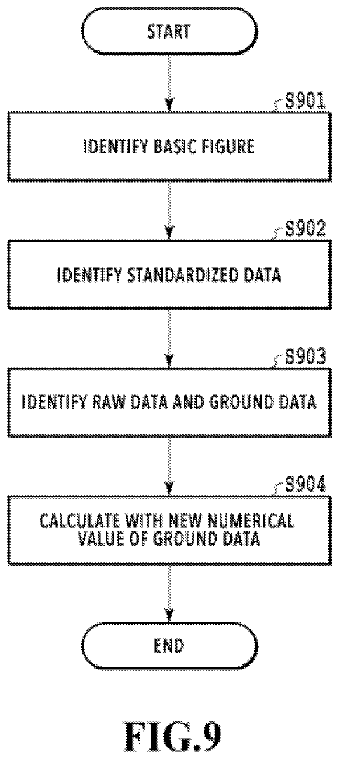

FIG. 9 is a sequence diagram illustrating a process procedure of the management information system 110 according to the embodiment of the present invention.

At step 901, the management information system 110 receives data from a terminal 140 for bank clerks for identifying the basic figures 305 that need to be regenerated in a data replacement process. In addition, the management information system 110 receives numerical values of the ground data from the terminal 140 for bank clerks.

At step 902, the management information system 110 refers to the basic figure database 209 to identify the pieces of the standardized data 303 and 304 composing the basic figures 305 identified with the data received at step 901.

At step 903, the management information system 110 refers to the calculation ground database 211 to identify the pieces of raw data 301 and ground data of the pieces of standardized data 303 and 304 identified at step S902.

At step 904, the management information system 110 calculates standardized data 303 and 304 based on the pieces of raw data 301 identified at step 903 and the numerical values of the ground data received at step 901. Further, the management information system 110 generates basic figures 305 based on the calculated standardized data 303 and 304.

As described above, with the invention of the present application, only by specifying the basic figures that need to be regenerated in a data replacement process and numerical values of the ground data, standardized data used for the management accounting and financial accounting of a financial institution or a financial holding company group can be easily regenerated in the data replacement process. Thus, information generated based on ground data having different values between departments and group companies (for example, information based on different exchange rates) can be recalculated using ground data having unified values, which makes it easy to compare information of a department or a group company with information of another under the same conditions.

Although embodiments of the present invention have been described until now, the above embodiments are mere examples, and the present invention is not limited to the above embodiments. It goes without saying that the present invention may be implemented as various different embodiments within the scope of the technical idea.

The scope of the present invention is not limited to the exemplary embodiments that have been described and illustrated in the figures but includes all embodiments that provide effects equivalent to the object of the present invention. Further, the scope of the present invention is not limited to the combinations of features of the invention defined by each claim but can be defined by any desired combination of specific features of all the disclosed features.

### REFERENCE SIGNS LIST

110 management information system
120 business system in a bank
130 business system in group companies
140 terminal for bank clerks
201 database compilation unit
202 extraction unit
203 common code assigning unit
204 basic figure generation unit
205 standardized data definition database
206 common code database
207 standardized data (B/S) database
208 standardized data (P/L) database
209 basic figure database
210 data replacement unit
211 calculation ground database
301 raw data
302 base data
303 standardized data (B/S)
304 standardized data (P/L)
305 basic FIG.
306 purpose-based database
401 element 1
402 element 2
403 element 3

1. A management information system connected to multiple business systems and terminals inside and outside a company, located in a home country and a foreign country, the management information system being a system to support management of a financial institution or a financial holding company group including the financial institution, wherein
the management information system comprises a data replacement unit, and
the data replacement unit is configured to
receive, from any of the terminals, data for identifying a basic figure to be regenerated in data replacement and a change value of ground data for performing the data replacement,
identify standardized data composing the basic figure identified with the received data,
recalculate the standardized data using the received change value of the ground data, and
regenerate the basic figure based on the recalculated standardized data, the basic figure being used for the management of the financial institution or the financial holding company group including the financial institution.

2. The management information system according to claim 1, wherein the standardized data is data generated by extracting data of one or more items out of base data managed by the business systems and assigning a common code to the extracted data.

3. The management information system according to claim 2, wherein the standardized data includes data on risk involved in an operation of the financial institution.

4. A method executed by a management information system connected to multiple business systems and terminals inside and outside a company, located in a home country and a foreign country, the management information system being a system to support management of a financial institution or a financial holding company group including the financial institution, the method comprising:
receiving, from any of the terminals, data for identifying a basic figure to be regenerated in data replacement and a change value of ground data for performing the data replacement,
identifying standardized data composing the basic figure identified with the received data,
recalculating the standardized data using the received change value of the ground data, and
regenerating the basic figure based on the recalculated standardized data, the basic figure being used for the management of the financial institution or the financial holding company group including the financial institution.

5. A non-transitory computer-readable storage medium having computer-executable instructions which causes, when executed by a processor, a management information system connected to multiple business systems and terminals inside and outside a company, located in a home country and a foreign country, the management information system being a system to support management of a financial institution or a financial holding company group including the financial institution, to perform a method comprising:
receiving, form any of the terminals, data for identifying a basic figure to be regenerated in data replacement and a change value of ground data for performing the data replacement,
identifying standardized data composing the basic figure identified with the received data,
recalculating the standardized data using the received change value of the ground data, and
regenerating the basic figure based on the recalculated standardized data, the basic figure being used for the management of the financial institution of the financial holding company group including the financial institution.

6. The management information system according to claim 1, wherein the standardized data includes data on risk involved in an operation of the financial institution.
